(19) United States
(12) Patent Application Publication
(10) Pub. No.: US 2026/0259318 A1
(43) Pub. Date: Sep. 3, 2026

(54) SPACEBORNE VERY-LONG BASELINE INTERFEROMETRIC SAR SYSTEM AND IMPLEMENTATION METHOD

(71) Applicant: Aerospace Information Research Institute, Chinese Academy of Sciences, Beijing (CN)

(72) Inventors: Yu WANG, Beijing (CN); YiDi WANG, Beijing (CN); YunJun ZHANG, Beijing (CN); Da LIANG, Beijing (CN); Meng ZHU, Beijing (CN); YongHua CAI, Beijing (CN); YiRong WU, Beijing (CN)

(21) Appl. No.: 19/380,768

(22) Filed: Nov. 5, 2025

(30) Foreign Application Priority Data
Feb. 28, 2025 (CN) 202510232907.9

(51) Int. Cl. G01S 13/90; G01S 13/02; G01S 13/34; G06F 30/20; G06F 111/06

(52) U.S. Cl. CPC G01S 13/9023; G01S 13/0218; G01S 13/346; G01S 13/9058; G06F 30/20; G06F 2111/06

(57) ABSTRACT

The present disclosure provides a design method and apparatus for a spaceborne very-long baseline interferometric SAR system, and belongs to the field of radar measurement. The design method includes: with specific to bistatic interferometry, analyzing relationships among an elevation accuracy, a phase error and a coherence, thereby deriving a relationship between the elevation accuracy and a perpendicular baseline; with specific to the bistatic interferometry, analyzing a relationship between the coherence and each of the perpendicular baseline and the critical baseline in conjunction with the critical baseline; acquiring a relationship between a ratio of the perpendicular baseline to the critical baseline and the elevation accuracy; performing InSAR time series deformation rate error analysis, thereby deriving a relationship between deformation rate accuracy and each error source; deriving an influence of decorrelation noise on the deformation rate accuracy; and acquiring a relationship between a ratio of coherent temporal baseline to a revisit time and the deformation rate accuracy. The present disclosure satisfies a demand of a high-accuracy topography and deformation measurement task of a spaceborne SAR technology.

### TECHNICAL FIELD

The present disclosure belongs to the field of radar measurement, in particular to a design method and apparatus for a spaceborne very-long baseline interferometric SAR system.

### BACKGROUND ART

The InSAR (Interferometric Synthetic Aperture Radar) technology can implement two major core functions of surface elevation measurement and deformation monitoring by using a phase difference of radar signals, and it has become a key technique in fields such as topographic mapping, geological disaster warning, and infrastructure safety assessment. The implementation of this technology depends on two typical observation modes:
1. single-pass mode: a spatial baseline is formed by synchronously observing the same area by means of two satellites or double antennae, and high-accuracy surface elevation information is extracted on the basis of a principle of differential interferometry. A typical application of the mode includes the digital elevation model (DEM) generation, glacier topographic mapping, etc.
2. Repeat-pass mode: a temporal baseline is formed by repeatedly revisiting the same area via single or multiple satellites, and slow surface deformation, such as fault creep and urban subsidence, is monitored.

However, with respect to increasing demands for topography and deformation measurement accuracy, there is still a problem of mutual constraints between system design and measurement accuracy in an existing InSAR system, and an analytical relationship among the spatial baseline, temporal baseline and InSAR measurement performance is still unclear. The extension of the spatial baseline is beneficial to elevation measurement, while the extension of the temporal baseline is beneficial to time series deformation measurement, however, no clear definition and quantitative analysis for a very-long spatial baseline and a very-long temporal baseline have been given yet in existing research.

For spatial baseline and elevation measurement, an interferometric SAR acquires elevation information by means of the spatial baseline, and a sensitivity thereof is directly proportional to the spatial baseline. The spatial baseline is defined as a component (focusing on a perpendicular spatial baseline, which is referred to perpendicular baseline hereafter) vertical to a line-of-sight direction of a radar beam in a baseline on a cross-track plane. By increasing a baseline length, the elevation measurement accuracy can be improved, however, a decorrelation phenomenon may be caused to affect the elevation measurement accuracy, and the spatial baseline cannot be extended infinitely. Therefore, it is urgent to establish restriction relationship between the baseline length and the elevation measurement accuracy to find the longest allowable interferometric baseline.

For temporal baseline and deformation measurement, InSAR can measure surface deformation using satellite observations acquired at different times. The temporal baseline is defined as a time difference of two SAR images of the interferogram. A coherent temporal baseline is defined as a time required from initial temporal decorrelation to decay to 1/e (approximately equal to 0.36) of the initial value. Usually, with the coherent temporal baseline increases, the deformation rate measurement accuracy can be improved, however, the coherence will be lowered with the increase of temporal baseline, thus, the coherent temporal baseline cannot be increased infinitely. Therefore, it is urgent to provide a spaceborne very-long baseline InSAR system to clarify the definition of a very-long temporal baseline and guide the design, research and development of the spaceborne InSAR system.

In conclusion, the existing InSAR technology faces dual constraints of baseline length and system design in terms of elevation and deformation measurement, and no definition method for a very-long spatial and temporal baselines has been formed yet. How to define high-robustness observation of the interferometric SAR under a very-long baseline through innovative error analysis has become a technical problem that needs to be broken through in the field of spaceborne radar remote sensing.

### BRIEF SUMMARY

In order to solve the above-mentioned technical problem, the present disclosure provides a design method and apparatus for a spaceborne very-long baseline InSAR system. Firstly, using bistatic interferometry as an example, the relationship among an elevation accuracy, a phase error and a coherence is analyzed, in which volume decorrelation and geometrical decorrelation are mainly considered, a relationship between a ratio of a perpendicular baseline to a critical baseline and the elevation accuracy is constructed in conjunction with the critical baseline, and an optimal length of the perpendicular baseline is analyzed, thereby defining a very-long spatial baseline; and a relationship between deformation rate measurement accuracy and each of atmospheric delay, decorrelation noise, system phase noise, orbital error, and DEM error is considered, a covariance matrix of the time series of decorrelation noise is mainly analyzed, geometrical decorrelation and temporal decorrelation are used, and a relationship between a coherent temporal baseline, a revisit time and long-term coherence is comprehensively considered to obtain a relationship between the ratio of the coherent temporal baseline to the revisit time and deformation rate accuracy, thereby defining a very-long temporal baseline. The present disclosure can guide the design of the spaceborne very-long baseline InSAR system, thereby satisfying a demand of a high-accuracy topography and deformation measurement task of a spaceborne SAR technology.

The present disclosure depends on a principle that the ratio of the perpendicular baseline to the critical baseline is used as a definition basis of a very-long spatial baseline, and influence factors of the elevation accuracy are classified to determine a mutual relationship between the both; and the ratio of the coherent temporal baseline to the revisit time is used as a definition basis of the very-long temporal baseline, and influence factors of the deformation rate accuracy are classified to determine a mutual relationship between the both.

In order to achieve the above-mentioned object, technical solutions of the present disclosure are that:
provided is a design method for a spaceborne very-long baseline InSAR system, including the following steps:
step 101, with specific to bistatic interferometry, analyzing relationships among an elevation accuracy, a phase error and a coherence, thereby deriving a relationship between the elevation accuracy and a perpendicular baseline;
step 102, with specific to the bistatic interferometry, analyzing a relationship between the coherence and each of the perpendicular baseline and a critical baseline in conjunction with the critical baseline;
step 103, acquiring a relationship between a ratio of the perpendicular baseline to the critical baseline and the elevation accuracy in conjunction with the step 101 and the step 102;
step 104, performing InSAR time series deformation rate error analysis, thereby deriving a relationship between deformation rate accuracy and each error source; and
step 105, deriving an influence of the decorrelation noise on the deformation rate accuracy; and acquiring a relationship between a ratio of coherent temporal baseline to a revisit time and the deformation rate accuracy in conjunction with the relationship derived in the step 104.

The present disclosure further provides a design apparatus for a spaceborne very-long baseline InSAR system, including the following modules:
a derivation module configured to, with specific to bistatic interferometry, analyze relationships among an elevation accuracy, a phase error and a coherence, thereby deriving a relationship between the elevation accuracy and perpendicular baseline;
an analysis module configured to, with specific to the bistatic interferometry, analyze a relationship between the coherence and each of the perpendicular baseline and a critical baseline in conjunction with the critical baseline;
a proportion and elevation accuracy acquisition module configured to acquire a relationship between a ratio of the perpendicular baseline to the critical baseline and the elevation accuracy in conjunction with the relationship derived by the derivation module and the relationship analyzed by the analysis module;
an error analysis module configured to perform InSAR time series deformation rate error analysis, thereby deriving a relationship between deformation rate accuracy and each error source; and
a relationship acquisition module configured to derive an influence of the decorrelation noise on the deformation rate accuracy; and acquire a relationship between a ratio of a coherent temporal baseline to a revisit time and the deformation rate accuracy in conjunction with the relationship derived by the error analysis module.

The present disclosure further provides an electronic device, including a memory, a processor, and a computer program stored on the memory and capable of running on the processor, wherein the steps of the above-mentioned design method for a spaceborne very-long baseline InSAR system are implemented when the program is executed by the processor.

The present disclosure further provides a non-transient computer-readable storage medium having a computer program stored thereon, wherein the steps of the above-mentioned design method for a spaceborne very-long baseline InSAR system are implemented when the computer program is executed by a processor.

### Beneficial Effects

The present disclosure considers each error source, focuses on an influence of decorrelation noise on elevation and deformation accuracy, balances a restrictive relationship among various factors, and gives the definition of a very-long spatial baseline and a very-long temporal baseline, and can provide important design system parameter reference for designers of the spaceborne InSAR system.

### BRIEF DESCRIPTION OF THE DRAWINGS

FIG. 1 is a flow diagram of a design method for a spaceborne very-long baseline InSAR system in an embodiment of the present disclosure;

FIG. 2a, FIG. 2b, FIG. 2c, FIG. 2d and FIG. 2e are diagrams of a relationship between a ratio of the perpendicular baseline to the critical baseline and elevation accuracy; wherein FIG. 2a shows a situation that the slope is −20°, FIG. 2b shows situation that the slope is −10°, FIG. 2c shows a situation that the slope is 0°, FIG. 2d shows a situation that the slope is 10°, and FIG. 2e shows a situation that the slope is 20°;

FIG. 3 is a diagram of a relationship between each of atmospheric delay, decorrelation noise, system noise and the total error to the deformation rate measurement accuracy;

FIG. 4a, FIG. 4b and FIG. 4c are diagrams of an influence of a relationship between the decorrelation noise and each of the coherent temporal baseline, revisit time and long-term coherence on deformation measurement accuracy; wherein FIG. 4a shows the influence of the coherent temporal baseline on the deformation measurement accuracy, FIG. 4b shows the influence of the revisit time on the deformation measurement accuracy, and FIG. 4c shows the influence of the long-term coherence on the deformation measurement accuracy; and

FIG. 5a and FIG. 5b are diagrams of a relationship between the ratio of the coherent temporal baseline to the revisit time and deformation rate accuracy; wherein FIG. 5a shows the two-dimensional relationship among the coherent temporal baseline, the revisit time and the deformation rate accuracy, and FIG. 5b shows the relationship between the ratio of the coherent temporal baseline to the revisit time and the deformation rate accuracy.

### DETAILED DESCRIPTION OF THE INVENTION

Technical solutions of the present disclosure will be described more clearly and completely below with reference to schematic diagrams in embodiments of the present disclosure. It should be noted that all embodiments based on the present disclosure should be regarded as falling within the protective scope of the present disclosure as long as they can be understood and implemented by those of ordinary skill in the art without additional innovative work.

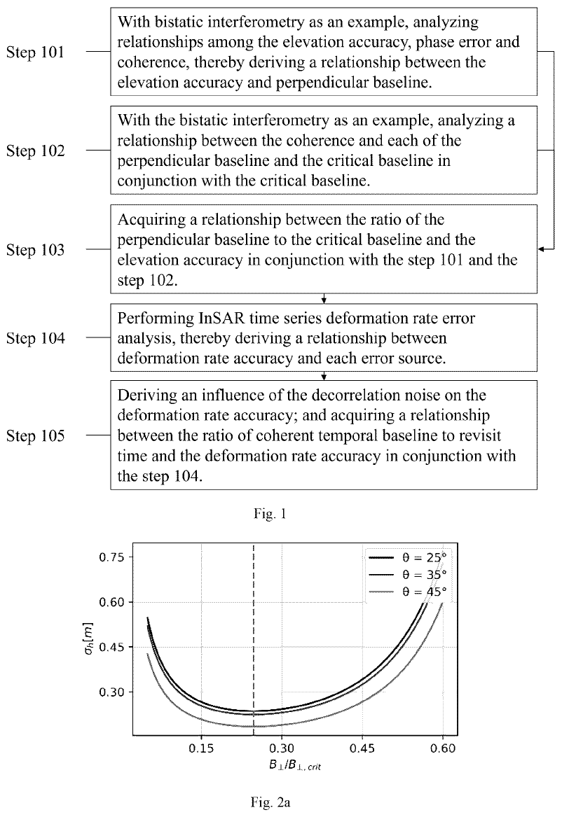

As shown in FIG. 1, an embodiment of the present disclosure discloses a design method for a spaceborne very-long baseline InSAR system, including the following steps:
step 101: using bistatic interferometry as an example, relationships among a phase error, an elevation accuracy and a coherence is analyzed, thereby deriving a relationship between the elevation accuracy and a perpendicular baseline, which includes:
a relationship between the elevation accuracy and the phase error in the bistatic interferometry is expressed as:

$${σ}_{h} = \frac{λ r sin θ}{2 π {B}_{⊥}} {σ}_{ϕ} \qquad ( 1 )$$

wherein σₕ is a standard deviation of the elevation accuracy, σ_{φ} is a standard deviation of the phase error, λ is a radar wavelength, r is a slant range distance of a primary sensor, θ is an incidence angle, and B_{⊥} is the perpendicular baseline.

The relationship between the phase error and the coherence is expressed as:

$${σ}_{ϕ}^{2} = {σ}_{d e c o r}^{2} + {σ}_{o t h e r}^{2} \qquad ( 2 )$$

$${σ}_{d e c o r} = \sqrt{\frac{1 - {γ}^{2}}{2 L {γ}^{2}}}$$

wherein σ_{decor} is a standard deviation of a phase error caused by decorrelation, σₒₜₕₑᵣ is a standard deviation of phase errors caused by other factors, L is the number of looks, and γ is the coherence.

A relationship between the elevation accuracy and the perpendicular baseline may be obtained according to formula (1) to formula (2):

$${σ}_{h}^{2} = {( \frac{λ r sin θ}{2 π {B}_{⊥}} )}^{2} ( \frac{1 - {γ}^{2}}{2 L {γ}^{2}} + {σ}_{o t h e r}^{2} ) \qquad ( 3 )$$

Step 102, using the bistatic interferometry as an example, a relationship between the coherence and each of the perpendicular baseline and a critical baseline is analyzed in conjunction with the critical baseline, which includes:
an expression of the critical baseline B_{⊥,crit} is shown as:

$${B}_{⊥ , crit} = \frac{2 {B}_{rg} λ r tan ( θ - φ )}{c} \qquad ( 4 )$$

wherein B_{rg} is a range bandwidth, λ is the radar wavelength, r is the slant range distance of the primary sensor, θ is the angle of incidence, φ is a local slope angle, and c is the speed of light.

An expression of the coherence γ is shown as:

$$γ = {γ}_{SQNR} \cdot {γ}_{fdc} \cdot {γ}_{sidelobe} \cdot {γ}_{c o r e g} \cdot {γ}_{a m b} \cdot {γ}_{SNR} \cdot {γ}_{v o l} \cdot {γ}_{baseline} \qquad ( 5 )$$

wherein γ_{SQNR} is a quantization noise decorrelation coefficient, γ_{fdc} is a Doppler decorrelation coefficient, γ_{sidelobe} is a sidelobe decorrelation coefficient, γ_{coreg} is a coregistration error decorrelation coefficient, γ_{amb} is an ambiguity decorrelation coefficient, γ_{SNR} is a thermal noise decorrelation coefficient, γᵥₒₗ is the volume decorrelation coefficient, and γ_{baseline} is a geometrical decorrelation coefficient. In the above-mentioned coherence coefficients, the volume decorrelation coefficient γᵥₒₗ and the geometrical decorrelation coefficient γ_{baseline} are related to the perpendicular baseline and the critical baseline.

An expression of the volume decorrelation coefficient γᵥₒₗ is shown as:

$${γ}_{vol} = \frac{{\int }_{0}^{{h}_{v}} {σ}^{0} ( z ) \cdot exp ( j 2 π \frac{{zB}_{⊥}}{λ r sin θ} ) \cdot dz}{{\int }_{0}^{{h}_{v}} {σ}^{0} ( z ) \cdot dz} \qquad ( 6 )$$

wherein z is an integral independent variable, hᵥ is a height of vegetation, exp( ) is an exponential function, j is an imaginary unit, and σ⁰(z) is an attenuation function of the vegetation to electromagnetic waves, which is expressed as:

$${σ}^{0} ( z ) = exp [ - 2 \cdot β \cdot \frac{{h}_{v} - z}{cos ( θ )} ] \qquad ( 7 )$$

wherein β is a single-way extinction coefficient of the electromagnetic waves in the vegetation.

An expression of the geometrical decorrelation coefficient γ_{baseline} is shown as:

$${γ}_{b a s e l i n e} = \{ \begin{matrix}1 - \frac{\vert {B}_{⊥} \vert}{{B}_{⊥ , crit}} , & \vert {B}_{⊥} \vert \leq {B}_{⊥ , crit} \\ 0 , & \vert {B}_{⊥} \vert > {B}_{⊥ , crit}\end{matrix} \qquad ( 8 )$$

A relationship between the coherence and each of the perpendicular baseline and the critical baseline may be obtained according to formula (4) to formula (8):

$$( 9 )$$

$$γ = k ( \frac{{\int }_{0}^{{h}_{v}} exp [ - 2 \cdot β \cdot \frac{{h}_{v} - z}{cos ( θ )} ] \cdot exp ( j 2 π \frac{2 {B}_{r g} ( \frac{\vert {B}_{⊥} \vert}{{B}_{⊥ , crit}} ) z cos ( θ - φ )}{c sin θ} ) \cdot dz}{{\int }_{0}^{{h}_{v}} exp [ - 2 \cdot β \cdot \frac{{h}_{v} - z}{cos ( θ )} ] \cdot dz} ) ( 1 - \frac{\vert {B}_{⊥} \vert}{{B}_{⊥ , crit}} ) ▯ f ( \frac{\vert {B}_{⊥} \vert}{{B}_{⊥ , crit}} )$$

wherein an intermediate parameter k=γ_{SQNR}·γ_{fdc}·γ_{sidelobe}·γ_{coreg}·γ_{amb}·γ_{SNR} is a constant of which the value is within a range of [0,1] and

$$f ( \frac{\vert {B}_{⊥} \vert}{{B}_{⊥ , crit}} )$$

represents a function ƒ(⋅) of which an independent variable is

$$\frac{\vert {B}_{⊥} \vert}{{B}_{⊥ , crit}} .$$

Step 103: a relationship between a ratio of the perpendicular baseline to the critical baseline and the elevation accuracy is acquired in conjunction with the step 101 and the step 102, which includes:
the relationship between the ratio of the perpendicular baseline to the critical baseline and the elevation accuracy may be acquired according to formula (3), formula (4), and formula (9):

$${σ}_{h}^{2} = {( \frac{c sin θ}{4 π tan ( θ - ϕ ) {B}_{rg} ( \frac{{B}_{⊥}}{{B}_{⊥ , crit}} )} )}^{2} ( \frac{1 - {f ( \frac{\vert {B}_{⊥} \vert}{{B}_{⊥ , crit}} )}^{2}}{2 {Lf ( \frac{\vert {B}_{⊥} \vert}{{B}_{⊥ , crit}} )}^{2}} + {σ}_{other}^{2} ) . \qquad ( 10 )$$

Step 104: InSAR time series deformation rate error analysis is performed, thereby deriving a relationship between deformation rate accuracy and each error source, which includes:
a standard deviation of the deformation rate measurement accuracy is correlated with atmospheric delay, decorrelation noise, system phase noise, orbital error, and DEM (Digital Elevation Model) error, which is specifically expressed as:

$${σ}_{vel}^{2} = {G}^{+} \cdot {C}_{def} \cdot {G}^{+ T} ( 1 , 1 ) \qquad ( 11 )$$

$${C}_{def} = {C}_{atm} + {C}_{decor} + {C}_{sys} + {C}_{orb} + {C}_{{topo}_{ε}} \qquad ( 12 )$$

$${C}_{atm} = diag \{ {σ}_{{atm}_{1}}^{2} , {σ}_{a t m 2}^{2} , … , {σ}_{a t {m}_{N}}^{2} \} \qquad ( 13 )$$

$${C}_{sys} = diag \{ {σ}_{s y {s}_{1}}^{2} , {σ}_{s y {s}_{2}}^{2} , … , {σ}_{s y {s}_{N}}^{2} \} \qquad ( 14 )$$

wherein G is a design matrix of the linear deformation model, such as

$$G = [ \begin{matrix}1 , ( {t}_{2} ‐ {t}_{1} ) \\ … \\ 1 , ( {t}_{N} ‐ {t}_{1} )\end{matrix} ] ,$$

t₁, t₂, . . . , t_{N} is the first, the second, . . . , the Nth time, C_{def} is a covariance matrix of a deformation time series, Cₐₜₘ is an atmospheric delay covariance matrix, C_{decor} is a decorrelation noise covariance matrix, C_{sys} is a system phase noise covariance matrix, C_{orb} is an orbital error covariance matrix, Cₜₒₚₒ_{_{ε}} is a DEM error covariance matrix, ⁺ is a generalized inverse of a matrix, the superscript T is a transpose of a matrix, diag{⋅} is a diagonal matrix, σₐₜₘ_{₁}, σₐₜₘ₂, . . . , σₐₜₘ_{_{N}} is a phase standard deviation of residual atmospheric delay error, σ_{sys}_{₁}, σ_{sys}_{₂}, . . . , σ_{sys}_{_{N}} is a standard deviation of system phase noise error, and N is the number of time points.
Step 105: an influence of the decorrelation noise on the deformation rate accuracy is derived; and a relationship between a ratio of coherent temporal baseline to a revisit time and the deformation rate accuracy is acquired in conjunction with the step 104, which includes:
the decorrelation noise covariance matrix C_{decor} (based on a small baseline subset) is expressed as:

$${C}_{decor} = {A}^{+} \cdot {C}_{d e c o r}^{stack} \cdot {A}^{+ T} = {( {A}^{T} A )}^{- 1} \cdot {A}^{T} {C}_{d e c o r}^{stsck} \cdot {A ( {A}^{T} A )}^{- 1} \qquad ( 15 )$$

$${C}_{decor}^{stack} = diag \{ {σ}_{d e c o {r}_{1}}^{2} , {σ}_{d e c o {r}_{2}}^{2} , … , {σ}_{d e c o {r}_{N}}^{2} \} \qquad ( 16 )$$

wherein A is a design matrix of small baseline subset phase estimation with the size of M×(N−1), and M is the number of interferograms, such as:

$$A = [ \begin{matrix}1 & 0 & 0 & … & 0 & 0 \\ 0 & 1 & 0 & … & 0 & 0 \\ - 1 & 1 & 0 & … & 0 & 0 \\ … & … & … & … & … & … \\ 0 & 0 & 0 & … & - 1 & 1\end{matrix} ] ;$$

$${C}_{d e c o r}^{s t a c k}$$

is a covariance matrix of an interferometric stack of decorrelation noise, σ_{decor}_{₁}, σ_{decor}_{₂}, . . . , σ_{decor}_{_{N}} is a standard deviation of decorrelation noise, and the superscript ⁻¹ is the inverse of a matrix, wherein an expression of a standard deviation of the decorrelation noise σ_{decor} and the coherence of the decorrelation noise of the time series are shown as:

$${σ}_{d e c o r} = \sqrt{\frac{1 - {γ}^{2}}{2 L {γ}^{2}}} \qquad ( 17 )$$

$$γ = {γ}_{baseline} \cdot {γ}_{temp}$$

$${γ}_{temp} = ( {γ}_{SNR} - {γ}_{∞} ) {e}^{- \frac{t}{τ}} + {γ}_{∞}$$

$${γ}_{SNR} = \frac{1}{1 - {SNR}^{- 1}}$$

wherein L is the number of looks, γ is the coherence, the geometrical decorrelation coefficient γ_{baseline} is calculated according to formula (8), γₜₑₘₚ is a temporal decorrelation coefficient, γ_{SNR} is a thermal noise decorrelation coefficient, SNR is a signal-to-noise ratio, τ is the coherent temporal baseline, t=N□t is a time series length, □t is the revisit time, N is the number of acquisitions, and γ_{∞} is a long-term coherence coefficient.

Technical solutions of the present disclosure will be further described in detail below in conjunction with specific embodiments.

### Embodiment 1

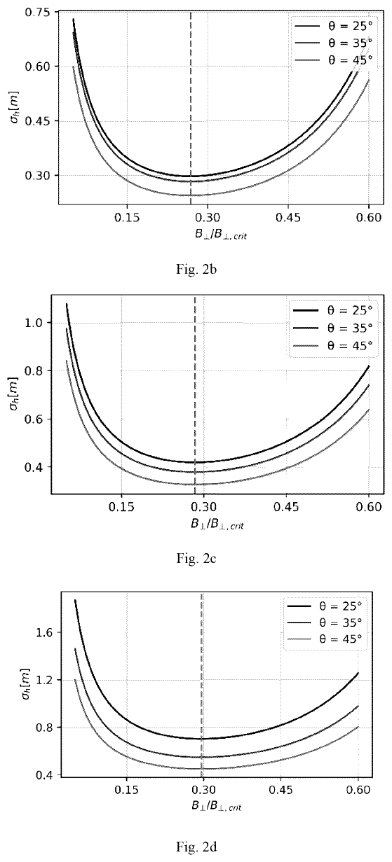

Simulated analysis is performed according to formula (10). Firstly, the constant is defined as k=0.8, the speed of light is defined as c=3×10⁸ m/s, the number of looks is defined as L=25, the range bandwidth is defined as, B_{rg}=80 MHz, the height of the vegetation is defined as hᵥ=20 m, the single-way extinction coefficient of the electromagnetic waves in the vegetation is defined as β=0.2 dB/m, and the standard deviation of the phase error caused by other factors is defined as σₒₜₕₑᵣ=0°. Under the conditions that respective simulated slopes are 0°, ±10° and ±20°, and incidence angles are 25°, 35° and 45°, results that the elevation accuracy changes with the ratio of the perpendicular baseline to the critical baseline are shown in FIG. 2a, FIG. 2b, FIG. 2c, FIG. 2d, and FIG. 2e, wherein FIG. 2a shows the situation that a slope is −20°, FIG. 2b shows situation that a slope is −10°, FIG. 2c shows a situation that a slope is 0°, FIG. 2d shows a situation that a slope is 10°, and FIG. 2e shows a situation that a slope is 20°. The improvement of the elevation accuracy is manifested in the reduction of the elevation error. The improvement of the elevation accuracy with the ratio of the perpendicular baseline to the critical baseline shows a trend of increasing first and then decreasing as a whole. Under the conditions of the same slope and different angles of incidence, the elevation error reaches the minimum value at the same ratio of the perpendicular baseline to the critical baseline, that is, the elevation accuracy reaches the maximum value at the time. Under the conditions of different slopes and the same angle of incidence, the elevation error changes with the slopes and reaches the minimum value when the ratio of the perpendicular baseline to the critical baseline is 24%-30%.

In an SAR system design, usually, the length of the perpendicular baseline used for interferometric altimetry is about 10% of that of the critical baseline. It is found by simulation experiments that the elevation accuracy will begin to be decrease when the perpendicular baseline is greater than 25%-30% of the critical baseline. Herein, in order to distinguish a boundary of a long baseline and a very-long baseline, the conventional system is defined as that the perpendicular baseline is 10% of the critical baseline, when the perpendicular baseline exceeds 10% of the critical baseline, the baseline is the long baseline, and the very-long baseline is twice as long as the long baseline.

In summary, in a topographically flat area, it is defined that a baseline with the ratio of the perpendicular baseline to the critical baseline being 10%-20% is the long baseline, and a baseline with the ratio of the perpendicular baseline to the critical baseline being 20%-30% is the very-long baseline. With the increase of topographic complexity and the slope, it is considered that the difficulty of phase unwrapping is increased, and thus, the elevation accuracy will be lowered fast. In a topographically complex area, it is defined that a baseline with the ratio of the perpendicular baseline to the critical baseline being 10%-17% is the long baseline, and a baseline with the ratio of the perpendicular baseline to the critical baseline being 17%-25% is the very-long baseline.

### Embodiment 2

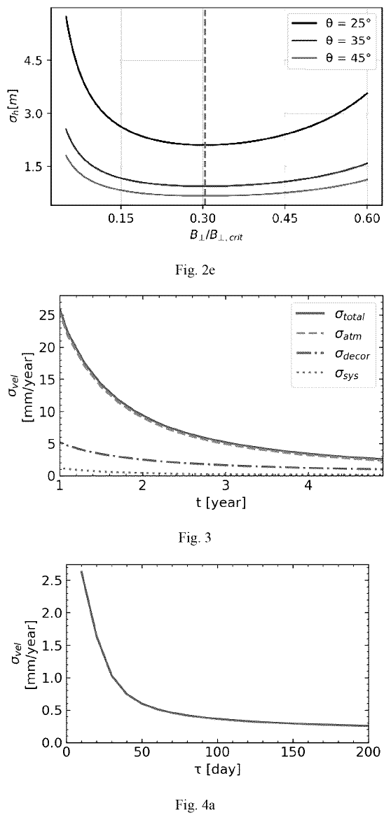

Firstly, the change of each error source with the length of time series and the deformation rate measurement accuracy are simulated, as shown in FIG. 3. The time series length (i.e., time) is t=3 years, the revisit time is ␣t=8 days, the coherent temporal baseline is τ=20 days, the long-term coherence coefficient is γ_{∞}=0.1, the phase standard deviation of the residual atmospheric delay error is σₐₜₘ=5 cm (herein, the residual atmospheric delay error refers to an error corrected by using a mainstream atmospheric delay correction method), the standard deviation of the system phase noise error is σ_{sys}=7.2°, and the orbital error and the DEM error are set as 0. It can be seen that the measurement accuracy is improved with the increase of the time series length. The contribution of uncertainty is that the atmospheric delay>the decorrelation noise>the system noise. The atmospheric delay, the system phase noise, the orbital error and the DEM error are all linearly and positively correlated with the deformation measurement accuracy. The atmospheric delay is an external environmental error and independent of the InSAR system design; and the influences of system phase error and orbital error are tiny and negligible at the current engineering hardware level. Therefore, the present disclosure focuses on paying attention to the influence of the decorrelation noise.

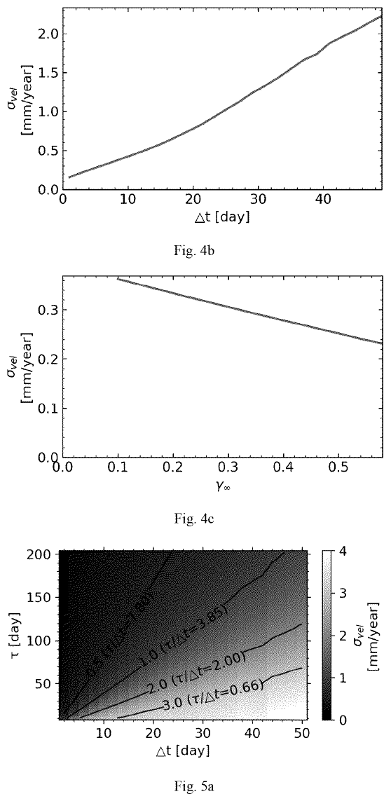

Secondly, with specific to the relationship between the decorrelation noise and each of the coherent temporal baseline, the revisit time and the long-term coherence, the influence of each of them on the deformation measurement accuracy is simulated, as shown in FIG. 4a, FIG. 4b, and FIG. 4c, wherein FIG. 4a shows the influence of the coherent temporal baseline on the deformation measurement accuracy, FIG. 4b shows the influence of the revisit time on the deformation measurement accuracy, and FIG. 4c shows the influence of the long-term coherence on the deformation measurement accuracy. The time series length is t=3 years, the revisit time is □t=8 days, the long-term coherence coefficient is γ_{∞}=0.1, and the coherent temporal baseline is τ=100 days. It can be seen that the decorrelation noise is determined by the coherent temporal baseline, the revisit time and the long-term coherence, and is in nonlinear correlation with the deformation measurement accuracy; and influences of the coherent temporal baseline and the revisit time is dominant, and the influence of long-term coherence is minimal.

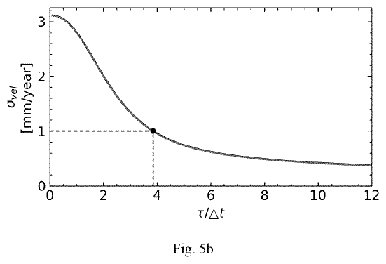

Based on above description, the relationship between the simulated deformation rate accuracy and the ratio of the coherent temporal baseline to the revisit time in the present disclosure is shown in FIG. 5a and FIG. 5b, wherein FIG. 5a shows the two-dimensional relationship among the coherent temporal baseline, the revisit time and the deformation rate accuracy, and FIG. 5b shows the relationship between the ratio of the coherent temporal baseline to the revisit time and the deformation rate accuracy. It can be seen that the both are nonlinear, and the greater the ratio is, the more accurate the rate measurement is. When the rate measurement accuracy reaches 1 millimeter/year, the corresponding ratio of the coherent temporal baseline to the revisit time is 3.85. Thus, the present disclosure gives a definition that the InSAR system is a very-long temporal baseline InSAR system when the ratio of the coherent temporal baseline to the revisit time is greater than or equal to 3.85. At the time, the coherent temporal baseline is a temporal baseline length with the coherence being greater than or equal to 0.36 (=1/e), and the parameter depends on the radar wavelength, ground object type, etc. The very-long temporal baseline with this ratio is defined to be independent of the radar wavelength, and could be used for guiding the parameter design of the revisit time of the InSAR system. For example, after the radar wavelength is selected according to the to-be-covered ground object type, the coherent temporal baseline is calculated, and then, the revisit time required by the system is selected according to a principle of the very-long temporal baseline.

The present disclosure further provides a design apparatus for a spaceborne very-long baseline InSAR system, including the following modules:
a derivation module configured to, with specific to bistatic interferometry, analyze relationships among the elevation accuracy, phase error and coherence, thereby deriving the relationship between the elevation accuracy and perpendicular baseline;
an analysis module configured to, with specific to the bistatic interferometry, analyze the relationship between the coherence and each of the perpendicular baseline and the critical baseline in conjunction with the critical baseline;
a proportion and elevation accuracy acquisition module configured to acquire a relationship between the ratio of the perpendicular baseline to the critical baseline and the elevation accuracy in conjunction with the derivation module and the analysis module;
an error analysis module configured to perform InSAR time series deformation rate error analysis, thereby deriving the relationship between deformation rate accuracy and each error source; and
a relationship acquisition module configured to derive the influence of the decorrelation noise on the deformation rate accuracy; and acquire a relationship between the ratio of coherent temporal baseline to revisit time and the deformation rate accuracy in conjunction with the error analysis module.

The present disclosure further provides an electronic device, including a memory, a processor, and a computer program stored on the memory and capable of running on the processor, wherein the steps of the above-mentioned design method for a spaceborne very-long baseline InSAR system are implemented when the program is executed by the processor.

The present disclosure further provides a non-transient computer-readable storage medium having a computer program stored thereon, wherein the steps of the above-mentioned design method for a spaceborne very-long baseline InSAR system are implemented when the computer program is executed by a processor.

It should be understood by the skilled in the art that the embodiments of the present disclosure may provide a method, system or computer program product. Therefore, forms of a complete hardware embodiment, a complete software embodiment or a software and hardware aspect combined embodiment may be adopted in the present disclosure. Moreover, a form of a computer program product executed on one or more computer-available storage media (including, but not limited to a magnetic disk memory, a CD-ROM and an optical memory) including computer-available program codes may be adopted in the present disclosure. The solutions in the embodiments of the present disclosure may be implemented by adopting various computer languages, such as an object-oriented programming language Java and an interpreted scripting language JavaScript.

The present disclosure is described with reference to flow diagrams and/or block diagrams of the method, device (system) and computer program product according to the embodiments of the present disclosure. It should be understood that each flow and/or block in the flow diagrams and/or the block diagrams as well as a combination of flows and/or blocks in the flow diagrams and/or the block diagrams may be implemented by computer program instructions. The computer program instructions may be provided to a general-purpose computer, a special-purpose computer, an embedded processor or processors of other programmable data processing devices to generate a machine, so that an apparatus for implementing specified functions in one or more flows in the flow programs and/or one or more blocks in the block diagrams is generated through the instructions executed by the computer or the processors of other programmable data processing devices.

These computer program instructions may also be stored in a computer-readable memory capable of guiding the computer or other programmable data processing devices to work in a specific way, so that the instructions stored in the computer-readable memory generate a product including an instruction apparatus, and the instruction apparatus implements the functions specified in the one or more flows in the flow diagrams and/or one or more blocks in the block diagrams.

These computer program instructions may also be loaded in the computer or other programmable data processing devices, so that a series of operation steps are performed on the computer or other programmable data processing devices to generate processing implemented by the computer, and furthermore, the instructions executed on the computer or other programmable data processing devices provide steps for implementing the specified functions in the one or more flows in the flow diagrams and/or one or more blocks in the block diagrams.

Although the preferred embodiments of the present disclosure have been described, those skilled in the art can make additional changes and modifications on these embodiments once they acquire the basic creative concept. Therefore, appended claims are intended to be explained to include the preferred embodiments and all the changes and modifications that fall within the scope of the present disclosure.

Apparently, those skilled in the art can make various alterations and variations to the present disclosure without departing from the spirit and scope of the present disclosure. Thus, if the alterations and variations of the present disclosure fall within the scope of the claims of the present disclosure and the equivalent technologies thereof, the present disclosure is also intended to cover the modifications and variations.

1. A design method for a spaceborne very-long baseline InSAR system, comprising the following steps:
step 101, with specific to bistatic interferometry, analyzing relationships among an elevation accuracy, a phase error and a coherence, thereby deriving a relationship between the elevation accuracy and a perpendicular baseline;
step 102, with specific to the bistatic interferometry, analyzing a relationship between the coherence and each of the perpendicular baseline and a critical baseline in conjunction with the critical baseline;
step 103, acquiring a relationship between a ratio of the perpendicular baseline to the critical baseline and the elevation accuracy in conjunction with the step 101 and the step 102;
step 104, performing InSAR time series deformation rate error analysis, thereby deriving a relationship between deformation rate accuracy and each error source, which comprises:
considering a relationship between deformation rate measurement accuracy and each of atmospheric delay, decorrelation noise, system phase noise, orbital error, and DEM error; and
step 105, deriving an influence of the decorrelation noise on the deformation rate accuracy; and acquiring a relationship between a ratio of coherent temporal baseline to a revisit time and the deformation rate accuracy in conjunction with the relationship derived in the step 104, which comprises: analyzing a covariance matrix of a time series of the decorrelation noise; and comprehensively considering the coherent temporal baseline, the revisit time and long-term coherence to obtain the relationship between the ratio of the coherent temporal baseline to the revisit time and the deformation rate accuracy.

2. The design method for a spaceborne very-long baseline InSAR system of claim 1, wherein the step 101 comprises: obtaining a relationship between the elevation accuracy and the perpendicular baseline according to the relationship between the elevation accuracy and the phase error and a relationship between the phase error and the coherence in the bistatic interferometry.

3. The design method for a spaceborne very-long baseline InSAR system of claim 2, wherein the step 102 comprises:
performing the analysis by using an expression of the critical baseline; and the coherence comprising quantization noise decorrelation, Doppler decorrelation, sidelobe decorrelation, coregistration error decorrelation, ambiguity decorrelation, thermal noise decorrelation, volume decorrelation, and geometrical decorrelation.

4. The design method for a spaceborne very-long baseline InSAR system of claim 3, wherein the step 102 further comprises:
analyzing the volume decorrelation and the geometrical decorrelation to obtain a relationship among the coherence, elevation accuracy, perpendicular baseline and critical baseline, which is expressed as:
$$( 9 )$$
$$γ = k ( \frac{{\int }_{0}^{{h}_{ν}} exp [ - 2 \cdot β \cdot \frac{{h}_{v} - z}{cos ( θ )} ] \cdot exp ( j 2 π \frac{2 {B}_{rg} ( \frac{\vert {B}_{⊥} \vert}{{B}_{⊥ , crit}} ) z cos ( θ - φ )}{c sin θ} ) \cdot dz}{{\int }_{0}^{{h}_{ν}} exp [ - 2 \cdot β \cdot \frac{{h}_{v} - z}{cos ( θ )} ] \cdot dz} j . ) ( 1 - \frac{\vert {B}_{⊥} \vert}{{B}_{⊥ , crit}} ) ▯ f ( \frac{\vert {B}_{⊥} \vert}{{B}_{⊥ , crit}} )$$
$${σ}_{h}^{2} = {( \frac{c sin θ}{4 π tan ( θ - φ ) {B}_{r g} ( \frac{{B}_{⊥}}{{B}_{⊥ , crit}} )} )}^{2} ( \frac{1 - {f ( \frac{\vert {B}_{⊥} \vert}{{B}_{⊥ , crit}} )}^{2}}{2 {Lf ( \frac{\vert {B}_{⊥} \vert}{{B}_{⊥ , crit}} )}^{2}} + {σ}_{other}^{2} ) \qquad ( 10 )$$
wherein γ is the coherence, an intermediate parameter k=γ_{SQNR}·γ_{fdc}·γ_{sidelobe}·γ_{coreg}·γ_{amb}·γ_{SNR} is a constant of which the value is within a range of [0,1], γ_{SQNR} is a quantization noise decorrelation coefficient, γ_{fdc} is a Doppler decorrelation coefficient, γ_{sidelobe} is a sidelobe decorrelation coefficient, γ_{coreg} is a coregistration error decorrelation coefficient, γ_{amb} is an ambiguity decorrelation coefficient, γ_{SNR} is a thermal noise decorrelation coefficient, σₕ is the standard deviation of the elevation accuracy, c is the speed of light, θ is an incidence angle, φ is a local slope, B_{rg} is a range bandwidth, B_{⊥} is the perpendicular baseline, B_{⊥,crit} is the critical baseline, σₒₜₕₑᵣ is a standard deviation of phase errors caused by other factors, L is the number of looks, β is s single-way extinction coefficient of electromagnetic waves in vegetation, z is an integral independent variable, hᵥ is a height of the vegetation, exp( ) is an exponential function, j is an imaginary unit, and
$$f ( \frac{\vert {B}_{⊥} \vert}{{B}_{⊥ , crit}} )$$
represents a function ƒ(⋅) of which an independent variable is
$$\frac{\vert {B}_{⊥} \vert}{{B}_{⊥ , crit}} .$$

5. The design method for a spaceborne very-long baseline InSAR system of claim 1, wherein the relationship between the ratio of the coherent temporal baseline to the revisit time and the deformation rate accuracy is expressed as:
$${σ}_{v e l}^{2} = {G}^{+} \cdot {C}_{def} \cdot {G}^{+ T} ( 1 , 1 ) \qquad ( 11 )$$
$${C}_{def} = {C}_{a t m} + {C}_{d e c o r} + {C}_{sys} + {C}_{o r b} + {C}_{{topo}_{ε}} \qquad ( 12 )$$
$${C}_{a t m} = diag \{ {σ}_{{atm}_{1}}^{2} , {σ}_{atm 2}^{2} , … , {σ}_{{atm}_{N}}^{2} \} \qquad ( 13 )$$
$${C}_{s y s} = diag \{ {σ}_{s γ {s}_{1}}^{2} , {σ}_{s γ {s}_{2}}^{2} , … , {σ}_{s γ {s}_{N}}^{2} \} \qquad ( 14 )$$
$${C}_{decor} = {A}^{+} \cdot {C}_{d e c o r}^{stack} \cdot {A}^{+ T} = {( {A}^{T} A )}^{- 1} \cdot {A}^{T} {C}_{d e c o r}^{stack} \cdot {A ( {A}^{T} A )}^{- 1} \qquad ( 15 )$$
$${C}_{d e c o r}^{stack} = diag \{ {σ}_{d e c o {r}_{1}}^{2} , {σ}_{d e c o {r}_{2}}^{2} , … , {σ}_{d e c o {r}_{N}}^{2} \} \qquad ( 16 )$$
$${σ}_{d e c o r} = \sqrt{\frac{1 - {γ}^{2}}{2 L {γ}^{2}}}$$
$$γ = {γ}_{baseline} \cdot {γ}_{t e m p}$$
$${γ}_{t e m p} = ( {γ}_{SNR} - {γ}_{∞} ) {e}^{\frac{t}{τ}} + {γ}_{∞}$$
$${γ}_{SNR} = \frac{1}{1 - {SNR}^{- 1}} \qquad ( 17 )$$
wherein σᵥₑₗ is a standard deviation of the deformation rate measurement accuracy, G is a design matrix of a linear deformation model, C_{def} is a covariance matrix of a deformation time series, Cₐₜₘ is an atmospheric delay covariance matrix, C_{decor} is a decorrelation noise covariance matrix, C_{sys} is a system phase noise covariance matrix, C_{orb} is an orbital error covariance matrix, Cₜₒₚₒ_{_{ε}} is a DEM error covariance matrix, ⁺ is a generalized inverse of a matrix, the superscript T is a transpose of a matrix, diag{⋅} is a diagonal matrix, σₐₜₘ_{₁}, σₐₜₘ₂, . . . , σₐₜₘ_{_{N}} is a phase standard deviation of a residual atmospheric delay error, σ_{sys}_{₁}, σ_{sys}_{₂}, . . . , σ_{sys}_{_{N}} is a standard deviation of a system phase noise error, N is the number of time points, A is a design matrix of small baseline subset phase estimation,
$${C}_{d e c o r}^{s t a c k}$$
is a covariance matrix of an interferometric stack of the decorrelation noise, σ_{decor}_{₁}, σ_{decor}_{₂}, . . . , σ_{decor}_{_{N}} is a standard deviation of the decorrelation noise, ⁻¹ is an inverse of a matrix, σ_{decor} is a standard deviation of the decorrelation noise,
$${σ}_{d e c o r} = \sqrt{\frac{1 - {γ}^{2}}{2 L {γ}^{2}}} ,$$
L is the number of looks, γ is the coherence, γ_{baseline} is a geometrical decorrelation coefficient, γₜₑₘₚ is a temporal decorrelation coefficient, γ_{SNR} is a thermal noise decorrelation coefficient, SNR is a signal-to-noise ratio, τ is the coherent temporal baseline, t=N␣t is a time series length, □t is the revisit time, and γ_{∞} is a long-term coherence coefficient.

6. A design apparatus for a spaceborne very-long baseline InSAR system, comprising the following modules:
a derivation module configured to, with specific to bistatic interferometry, analyze relationships among an elevation accuracy, a phase error and a coherence, thereby deriving a relationship between the elevation accuracy and perpendicular baseline;
an analysis module configured to, with specific to the bistatic interferometry, analyze a relationship between the coherence and each of the perpendicular baseline and a critical baseline in conjunction with the critical baseline;
a proportion and elevation accuracy acquisition module configured to acquire a relationship between a ratio of the perpendicular baseline to the critical baseline and the elevation accuracy in conjunction with the relationship derived by the derivation module and the relationship analyzed by the analysis module;
an error analysis module configured to perform InSAR time series deformation rate error analysis, thereby deriving a relationship between deformation rate accuracy and each error source, which comprises:
considering a relationship between deformation rate measurement accuracy and each of atmospheric delay, decorrelation noise, system phase noise, orbital error, and DEM error; and
a relationship acquisition module configured to derive an influence of the decorrelation noise on the deformation rate accuracy; and acquire a relationship between a ratio of a coherent temporal baseline to a revisit time and the deformation rate accuracy in conjunction with the relationship derived by the error analysis module, which comprises: analyzing a covariance matrix of a time series of the decorrelation noise; and comprehensively considering the coherent temporal baseline, the revisit time and long-term coherence to obtain the relationship between the ratio of the coherent temporal baseline to the revisit time and the deformation rate accuracy.

7. An electronic device, comprising a memory, a processor, and a computer program stored on the memory and capable of running on the processor, wherein the steps of the design method for a spaceborne very-long baseline InSAR system of claim 1 are implemented when the program is executed by the processor.

8. A non-transient computer-readable storage medium having a computer program stored thereon, wherein the steps of the design method for a spaceborne very-long baseline InSAR system of claim 1 are implemented when the computer program is executed by a processor.
